(19) United States
(12) Patent Application Publication
(10) Pub. No.: US 2017/0224185 A1
(43) Pub. Date: Aug. 10, 2017

(54) DUAL MODE VEHICLE MOUNTED CLEANING SYSTEM

(71) Applicant: Harris Research, Inc., Nashville, TN (US)

(72) Inventors: Christopher Wayne Smith, Logan, UT (US); Sterling Elliot Nesbit, Malad City, ID (US); Dale Jensen, Smithfield, UT (US)

(21) Appl. No.: 15/428,011

(22) Filed: Feb. 8, 2017

Related U.S. Application Data
(60) Provisional application No. 62/292,785, filed on Feb. 8, 2016.

(51) Int. Cl. A47L 11/40; A47L 11/30; A47L 11/34; F01N 5/02; F01P 3/20

(52) U.S. Cl. CPC A47L 11/4083; F01N 5/02; F01P 3/20; A47L 11/34; A47L 11/30; A47L 11/4044; A47L 11/4016; B62D 63/02

(57) ABSTRACT

An apparatus, system, and method for dual-mode vehicle-mounted cleaning are provided. In one embodiment, the apparatus includes a heat-exchanger subsystem having first and second heat-receiving pathways and a heat-providing pathway. Heat exhaust from a combustion engine is routed through the heat-providing pathway to transfer heat to both the first and second heat-receiving pathways. The first heat-receiving pathway, the second heat-receiving pathway, and the heat-providing pathway are fluidly independent of each other. The apparatus also includes a first liquid pathway fluidly coupled to the first heat-receiving pathway, configured to direct a hard-surface cleaning liquid, by a first pump, through the first heat-receiving pathway to a hard-surface cleaning tool, and a second liquid pathway fluidly coupled to the second heat-receiving pathway, configured to direct a soft-surface cleaning liquid, at a lower pressure than a first liquid in the first liquid pathway, through the second heat-receiving pathway to a soft-surface cleaning tool.

### CROSS-REFERENCES TO RELATED APPLICATIONS

This application claims the benefit of, U.S. Provisional Patent Application No. 62/292,785 entitled “DUAL MODE VEHICLE MOUNTED CLEANING SYSTEM” and filed on Feb. 8, 2016 for Christopher Wayne Smith, et al., which is incorporated herein by reference.

### FIELD

This application relates generally to floor cleaning devices, and more particularly relates to vehicle-mounted cleaning systems.

### BACKGROUND

Portable cleaning systems, such as vehicle-mounted devices, are generally designed to perform a specific cleaning process. For example, certain cleaning systems are configured for cleaning carpets and upholstery while other, separate systems are configured for cleaning tile and stone. In other words, in order for a user to clean different types of surfaces or different materials at a certain location, the user must have multiple different cleaning systems on-site for each type of surface or material to be cleaned. Operating multiple cleaning systems at each site requires extra capital and increases the material and operating costs of working in the cleaning industry.

### SUMMARY

A dual-mode vehicle-mounted cleaning apparatus, system, and method are provided for cleaning both hard and soft flooring surfaces. In one embodiment, the apparatus includes a power subsystem comprising a combustion engine configured to power a vacuum pump, a low-pressure pump, and a high-pressure pump, and a heat-exchanger subsystem comprising first and second heat-receiving pathways and a heat-providing pathway, wherein heat exhaust from at least one of the combustion engine and the vacuum pump is configured to flow through the heat-providing pathway to transfer heat to both the first and second heat-receiving pathways, wherein the first heat-receiving pathway, the second heat-receiving pathway, and the heat-providing pathway are fluidly independent of each other.

The apparatus may also include a low-pressure liquid pathway fluidly coupled to the first heat-receiving pathway, wherein, in the carpet-upholstery cleaning mode, a carpet-upholstery cleaning liquid is configured to be pumped, by the low-pressure pump, through the first heat-receiving pathway to a carpet-upholstery cleaning tool, and a high-pressure liquid pathway fluidly coupled to the second heat-receiving pathway, wherein, in the hard-surface cleaning mode, a hard-surface cleaning liquid is configured to be pumped, by the high-pressure pump, through the second heat-receiving pathway to a hard-surface cleaning tool.

In one embodiment, the heat exhaust configured to flow through the heat-providing pathway is from the combustion engine and the vacuum pump. In another embodiment, the heat-exchanger subsystem comprises an exhaust diverter operable to route heat exhaust from the combustion engine to bypass the heat-providing pathway, thereby controlling a temperature of the carpet-upholstery cleaning liquid in the carpet-upholstery cleaning mode. In yet another embodiment, the high-pressure liquid pathway is coupled to a recirculation manifold downstream from the heat-exchanger subsystem, wherein the recirculation manifold is operable to control how much of the hard-surface cleaning liquid recirculates upstream of the heat-exchanger subsystem and how much of the hard-surface cleaning liquid is dumped to a waste tank, thereby controlling a temperature of the hard-surface cleaning liquid in the hard-surface cleaning mode.

In another embodiment, the combustion engine is independent and separate from a powertrain engine of the vehicle, and the heat-exchanger subsystem comprises a single heat-exchanger unit. Additionally, the carpet-upholstery cleaning mode and the hard-surface cleaning mode may not be concurrently operable. The apparatus may also include a vacuum pathway fluidly coupling the vacuum pump, a waste tank, and a liquid extraction tool.

In one embodiment, the first heat-receiving pathway is made from a first non-corrosive metal material and the second heat-receiving pathway is made from a second metal material different than the first corrosion resistant metal material.

The method and system are provided to implement the embodiments of the apparatus.

### BRIEF DESCRIPTION OF THE DRAWINGS

In order that the advantages of the subject matter of the present disclosure will be readily understood, a more particular description of the subject matter will be rendered by reference to specific embodiments that are illustrated in the appended drawings. Understanding that these drawings depict only typical embodiments of the subject matter of the present disclosure and are not therefore to be considered to be limiting of its scope, the subject matter will be described and explained with additional specificity and detail through the use of the accompanying drawings, in which:

FIG. 1 is a schematic block diagram illustrating one embodiment of a portable cleaning system mounted in a vehicle 10, according to one embodiment of the present disclosure;

FIG. 2 is a schematic block diagram of the vehicle mounted cleaning system of FIG. 1, according to one embodiment, that is switchable between a carpet-upholstery (“soft surface”) cleaning mode and a tile/stone (“hard-surface”) cleaning mode;

FIG. 3 is a schematic block diagram of various liquid pathways in the vehicle mounted cleaning system, according to one embodiment of the present disclosure;

FIG. 4 is a schematic block diagram of various heat exhaust and vacuum pathways in the vehicle mounted cleaning system, according to one embodiment of the present disclosure;

FIG. 5 is a schematic block diagram of a controller in accordance with embodiments of the present disclosure; and

FIG. 6 is a schematic flow chart diagram of a method 600 for successively cleaning two different types of surfaces, according to one embodiment.

### DETAILED DESCRIPTION

The subject matter of the present disclosure has been developed in response to the present state of the art in cleaning systems. Accordingly, the subject matter of the present disclosure has been developed to provide a system and method for utilizing two different cleaning liquids, which may include a low-pressure liquid and a high-pressure liquid, to clean two different types of surfaces/materials, respectively, that overcome many or all or some shortcomings in the prior art.

Reference throughout this specification to features, advantages, or similar language does not imply that all of the features and advantages that may be realized with the subject matter of the present disclosure should be or are in any single embodiment of the subject matter. Rather, language referring to the features and advantages is understood to mean that a specific feature, advantage, or characteristic described in connection with an embodiment is included in at least one embodiment of the subject matter of the present disclosure. Thus, discussion of the features and advantages, and similar language, throughout this specification may, but do not necessarily, refer to the same embodiment.

Furthermore, the described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Similarly, reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

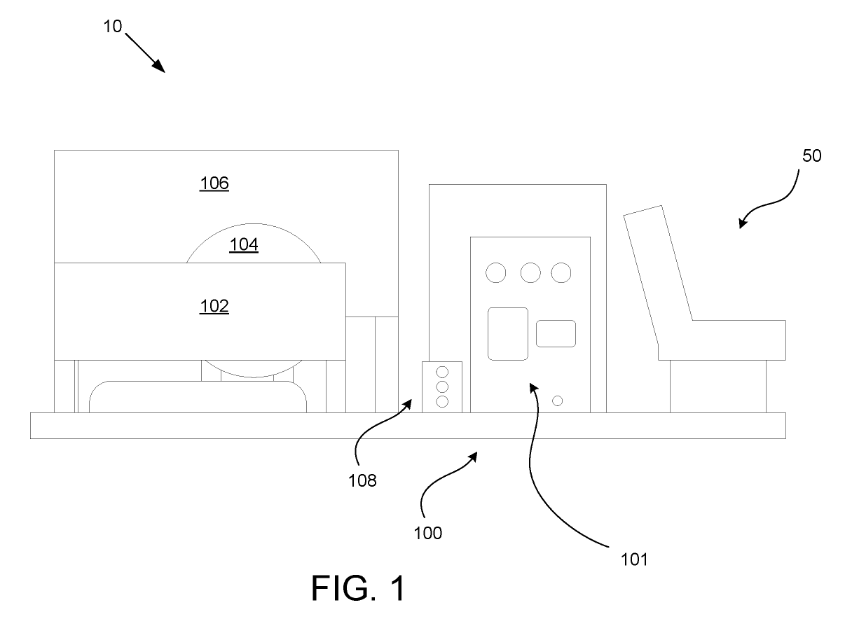

FIG. 1 is a schematic block diagram illustrating one embodiment of a portable cleaning system 100 mounted in a vehicle 10, according to one embodiment of the present disclosure. The vehicle 10 may be a van, a truck, trailer, or other automobile that can drive or be towed to different locations to perform on-site cleaning. The vehicle 10 may include various tanks (e.g., storage, waste, etc.) 102, hose reels 104, storage racks 106 for holding bins that can hold cleaning tools and cleaning compounds, etc. For example, the vehicle 10 may include water storage tanks and/or may include a water input interface 108, which allows a user to hook up to an on-site water source. In one embodiment, as shown in FIG. 1, the portable cleaning system 100, which is shown and described in greater detail with reference to the remaining figures, is positioned behind the front seats 50 of the vehicle 10, thereby enabling easy access to the various controls 101 of the cleaning system 100. In other words, the diagram of FIG. 1 generally resembles the layout of a cleaning system 100 implemented within a cargo van, with the cleaning system 100 components accessible through side and rear access doors. Many of the components of the vehicle 10 have been omitted for clarity, however it is contemplated that the components of the vehicle 10 may be used in the below described embodiments. For example, the cooling system of the vehicle (i.e., the coolant that circulates through the engine and radiator) may be used to provide heat to the heat exchanger, as will be described below.

As described above, to clean two different types of materials, such as carpet and tile, conventional cleaning users generally need to have two stand-alone devices that are each configured to clean a single type of material/surface. For example, a cleaning liquid that is specifically prepared to remove dirt and stains from carpet and upholstery may not need to be deployed at as high of a pressure as, for instance, another cleaning liquid that is specifically designed to clean tile or other hard-surfaces. In other words, due to the different composition, temperature, and pressure properties involved with cleaning different types of materials, conventional cleaning practices have included bringing multiple devices (i.e., multiple vehicles) to locations that need to clean multiple different types of materials/surfaces.

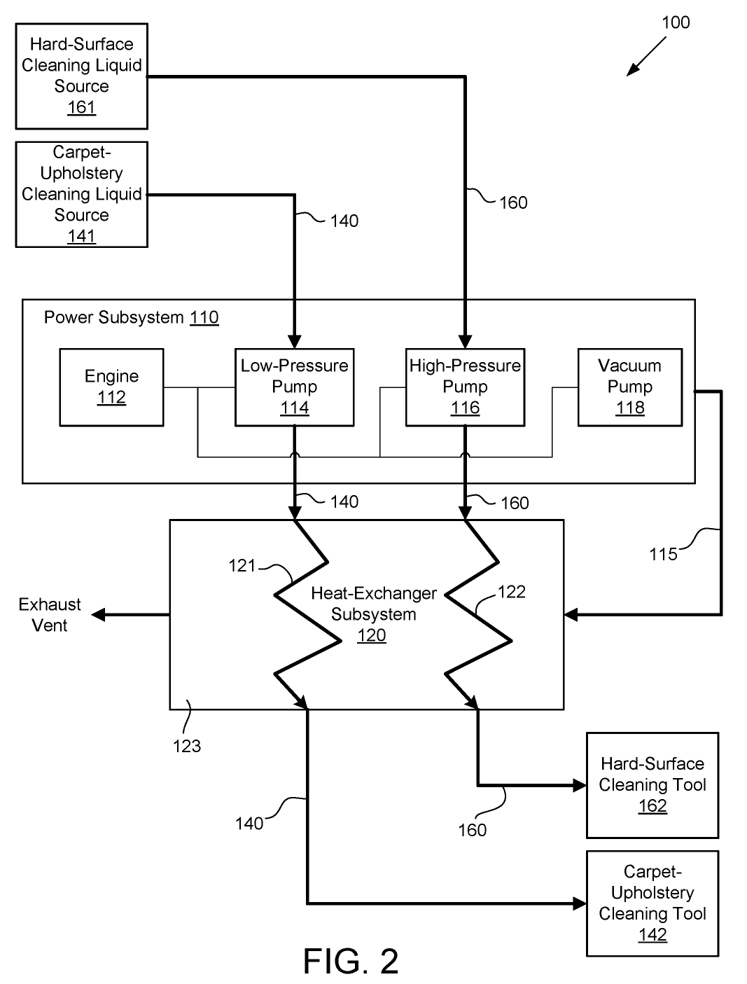

FIG. 2 is a schematic block diagram of the vehicle mounted cleaning system 100 of FIG. 1, according to one embodiment, that is switchable between a carpet-upholstery (“soft surface”) cleaning mode and a tile/stone (“hard-surface”) cleaning mode. In other words, the system 100 of the present disclosure allows for two different liquids (e.g., configured to clean different materials) flowing through two different pathways (i.e., isolated from each other) to be independently controlled (e.g., temperature and pressure) using a single vehicle cleaning system/device. More specifically, the two cleaning liquids are heated using the same source of heat in the same heat-exchanger subsystem, as will be described in greater detail below. The cleaning system 100 generally includes a power subsystem 110, a heat-exchanger subsystem 120, a low-pressure liquid pathway 140, and a high-pressure liquid pathway 160.

The power subsystem 110 includes a combustion engine 112 that provides power to the powered components of the system 100. For example and according to one embodiment, the combustion engine 112 powers (e.g., via electricity generated by the engine 112) a low-pressure pump 114, a high-pressure pump 116, and a vacuum pump 118 (also known as a blower or a vacuum blower). While in one embodiment the combustion engine 112 may be the powertrain engine of the vehicle, in another embodiment the power subsystem 110 is independent of the powertrain and power system of the vehicle. In other words, the combustion engine 112 of the cleaning system 100 may be a stand-alone engine that is specifically designed and configured to power the various pumps and/or blowers of the cleaning system 100.

The heat exhaust 115 from one or more of the engine 112 and the pumps 114, 116, 118 is conveyed to the heat-exchanger subsystem 120 as the heat source. In other words, the heat exhaust 115 from the power subsystem 110 is routed to flow through a heat-providing pathway 123 of the heat exchanger. Throughout the present disclosure, the term “heat exhaust” refers to any heat emitted from the power subsystem 110. For example, in one embodiment heat exhaust from the combustion engine 112 includes the actual combustion products flowing from the combustion chambers of the engine 112. In another embodiment, the heat exhaust refers to the heat that flows through the engine cylinders and is transferred via convection and radiation to the ambient air. In another embodiment, the heat exhaust refers to the heat that is extracted from the engine via the engine coolant, which may then be circulated through the heat-exchanger subsystem 120. Thus, the heat exhaust 115 may include air and or liquid that has been heated as it passes over or through the hot engine 112. The heat exhaust 115 may also include air that has been heated by the operation of the pumps 114, 116, 118. For example, heat produced from the operating temperature of the pumps 114, 116, 118 may be a component of the heat exhaust 115 that is routed to the heat-exchanger subsystem 120 as the heat-providing fluid.

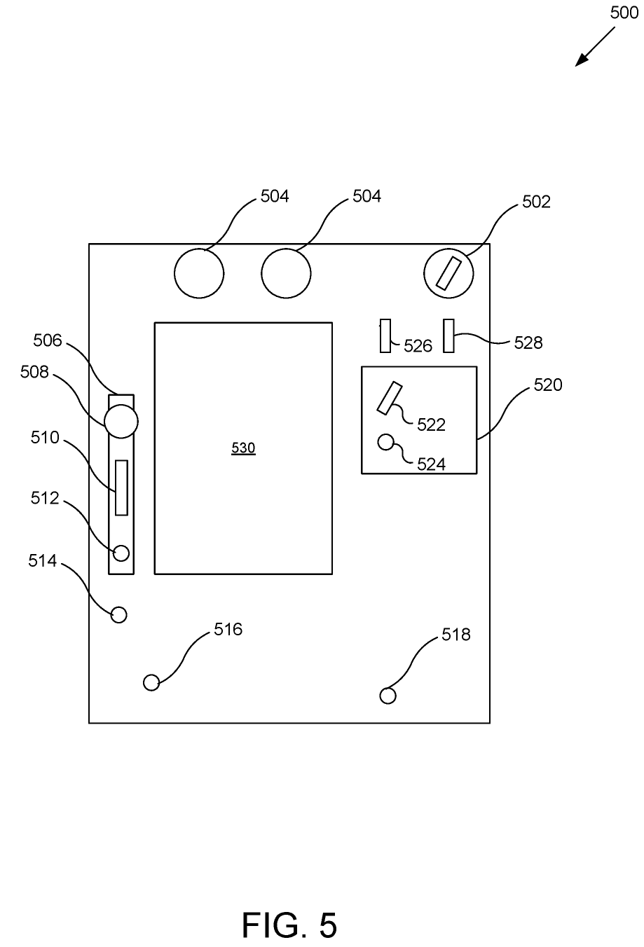

In one embodiment, the heat-exchanger subsystem 120 is configured to utilize a heated gas and a heated liquid to heat the cleaning liquids 140, 150. In another embodiment, the heat-exchanger subsystem 120 is configured to select either heated exhaust gas or heated liquid (i.e., engine coolant) as the source of heat. In yet another embodiment, the controller (see FIG. 5) selects a heat source based on a desired target temperature. For example, if a temperature is required for the hard surface cleaning solution that is greater than the exhaust gasses of the pumps, the controller may select the heated liquid from the engine to pass through

The low-pressure pump 114 is configured to pump a soft-surface cleaning liquid from a source 141 through the low-pressure liquid pathway 140. The low-pressure liquid pathway 140 is fluidly coupled to the heat exchanger subsystem 120. The high-pressure pump 116 is configured to pump a hard-surface cleaning liquid from a source 161 through the high-pressure liquid pathway 160. The high-pressure liquid pathway 160 is also fluidly coupled to the heat-exchanger subsystem 120. The liquid pathways 140, 160 include the piping, tubing, valves, regulators, gauges, etc., for routing the respective liquids through the heat-exchanger subsystem 120 and ultimately to the respective cleaning tools for application.

In one embodiment, the carpet-upholstery cleaning liquid is a pre-mixed solution of one or more cleaning agents/compounds and water. The low-pressure provided by the low-pressure pump 114, in one embodiment, is less than 150 pounds per square inch (“psi”). In another embodiment, the low-pressure is between about 120 psi and 125 psi. In one embodiment, the hard-surface cleaning liquid is water (e.g., one or more cleaning agents/compounds may be separately applied to the tile or stone before the high-pressure water is applied). In one embodiment, the high-pressure provided by the high-pressure pump 116 is greater than 200 psi. In yet another embodiment, the term “high-pressure” refers to pressures between about 400 psi and 2000 psi or 400 psi and 1000 psi. The vacuum pump 118 is configured to provide suction that is used to extract the cleaning liquids once the cleaning treatment has been performed. In one embodiment, the vacuum pump 118 is a vacuum blower and the byproduct heat from the operation of the blower is routed to the heat-exchanger subsystem 120 as heat exhaust 115.

The heat-exchanger subsystem 120, as mentioned above, enables in one embodiment, a single source of heat (i.e., the heat exhaust 115) to heat both cleaning liquids. In another embodiment, the heat-exchanger subsystem 120 enables multiple sources of heat-to-heat the cleaning liquids. The heat-exchanger subsystem 120 may include first and second heat-receiving pathways 121, 122 and a heat-providing pathway 123. The soft-surface cleaning liquid flowing at the low pressure through the low-pressure liquid pathway 140 is directed to the first heat-receiving pathway 121 and the hard-surface cleaning liquid flowing at the high-pressure through the high-pressure liquid pathway 160 is directed to the second heat-receiving pathway 122. The heat exhaust 115 from the power subsystem 110 may flow through the heat-providing pathway 123. Each of these pathways 121, 122, 123 of the heat-exchanger subsystem 120 maintain their respective fluids isolated from each other. In another embodiment, the heat-exchanger subsystem includes multiple heat-providing pathways 123, with each being maintainable at a different temperature. Accordingly, the soft-surface cleaning solution may be maintained at a different temperature than the hard-surface cleaning solution. Similarly, different temperatures of cleaning solutions may be maintained by altering the flow rates of the cleaning solutions through the heat-exchanger subsystem.

While it is expected that many different types of heat exchangers may be implemented in the heat-exchanger subsystem 120, in one embodiment the heat-exchanger subsystem 120 includes a finned tube heat exchanger unit. In other words, both of the heat receiving pathways 121, 122 may be finned tubes and the exhaust gas or liquid 115 may flow over the tubes inside a heat exchanger to transfer heat to the respective liquids flowing there through. After passing through the heat-exchanger subsystem 120, the heat exhaust 115 may vent to the atmosphere, or the liquid may be cycled back to the engine 112.

In one embodiment, the second heat-receiving pathway 122 may be disposed upstream from the first heat-receiving pathway 121 relative to the direction of flow of the heat exhaust 115 through the heat-providing pathway 123. Due to the higher pressure of the hard-surface cleaning liquid flowing through the second heat-receiving pathway 122, the required heat transfer flux to the hard-surface cleaning liquid may be greater than that of the carpet-upholstery cleaning liquid, thus justifying the position of the second heat-receiving pathway 122 upstream of the first heat-receiving pathway 121.

However, in other embodiments the first heat-receiving pathway 121 may be upstream of the second heat-receiving pathway 122 or both pathways 121, 122 may be intermingled so that neither pathway 121, 122 is considered to be upstream of the other. In one embodiment, the cleaning liquids may be pumped into separate heat-exchanger units, which in turn have their heat-providing pathways 123 fluidly coupled together (e.g., in series) to enable the heat exhaust 115 to flow through both units. In another embodiment, a single heat-exchanger unit is employed having two fluidly isolated heat-receiving pathways/coils disposed therein.

In one embodiment, first heat-receiving pathway 121 is made from a first corrosion resistant metal material and the second heat-receiving pathway 122 is made from a second metal material different from the first corrosion resistant metal material. In other words, since the carpet-upholstery cleaning liquid flowing through the first heat-receiving pathway 121, according to one embodiment, includes some pre-mixed cleaning agents/compounds, the first heat-receiving pathway 121 may need to be made from a corrosion resistant material due to the increased corrosively or otherwise increased chemical activity of the carpet-upholstery cleaning liquid when compared with the hard-surface cleaning liquid. For example, the first heat-receiving pathway 121 may be stainless steel tubes/coils while the second heat-receiving pathway 122 may be copper tubes/coils. Such a configuration allows for cost savings because the high-pressure hard surface cleaning liquid flowing through the second heat-receiving pathway 122, according to one embodiment, does not need to be made from a corrosion resistant material.

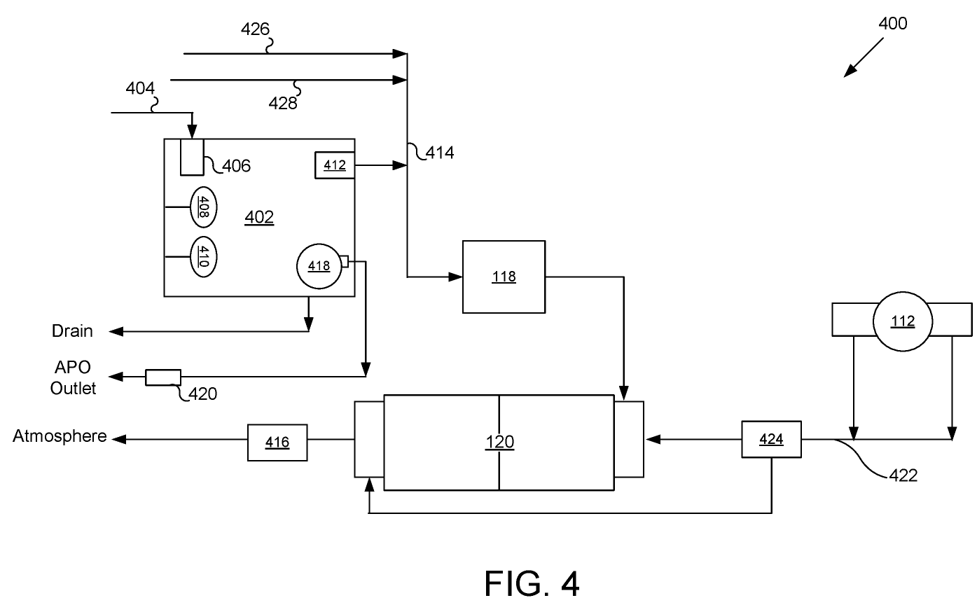

In one embodiment, the temperatures of the cleaning liquids delivered to the respective cleaning tools are controlled in different manners. In other words, in one embodiment the manipulated variables of the feedback temperature control loops for the two cleaning liquids are independent. For example, in one embodiment the temperature of the carpet-upholstery cleaning liquid is controlled by diverting all or a portion of the heat exhaust to bypass the heat-providing pathway 123 of the heat-exchanger subsystem 120 (or at least bypass a portion of the heat-providing pathway 123 of the heat-exchanger subsystem 120). In one embodiment, only one of the sources of the heat exhaust 115 may bypass the heat-exchanger subsystem 120. For example, as shown in FIG. 4, heat exhaust from the engine 112 may be controlled by the controller (via a diverter valve) to bypass the heat-exchanger subsystem 120 while the heat exhaust from other components, such as the vacuum motor/blower 118, may be configured to always flow through the heat-providing pathway 123 of the heat-exchanger subsystem 120 (i.e., there is no option to divert the heat exhaust from the vacuum motor/blower 118). In other embodiments, portions of the heat exhaust from one or more of the components of the power subsystem 110 may be collectively or individually diverted to provide further control over the heat transfer.

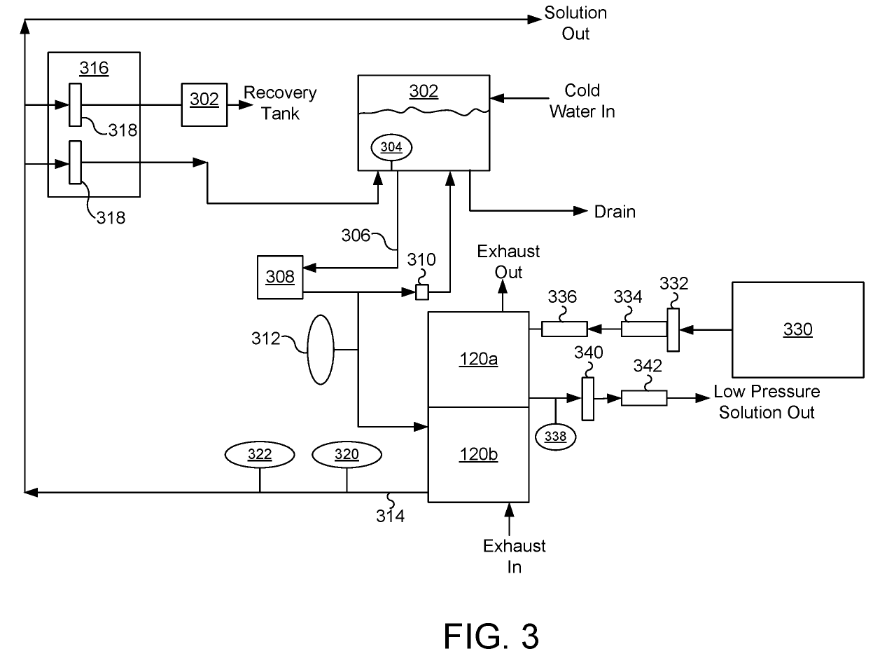

The temperature of the hard-surface cleaning liquid, according to one embodiment, may be controlled by adjusting the recycle ratio of the hard-surface cleaning liquid itself. In other words, if the temperature of the hard-surface cleaning liquid exiting the heat-exchanger is too low, all (or at least a comparatively greater portion) of the hard-surface cleaning liquid may be recirculated upstream to a water box (see FIG. 3), thereby allowing the hard-surface cleaning liquid to pass through the heat-exchanger again to further increase its temperature. Once the temperature of the hard-surface cleaning liquid has reached or exceeded a desired temperature, the recycle ratio of the hard-surface cleaning liquid may be changed so that little or none of the cleaning liquid is recirculated upstream. In certain embodiments, the heated and high-pressure hard-surface cleaning liquid may even be dumped into a waste tank if the temperature is too high. In other words, the temperature of the low-pressure, carpet-upholstery cleaning liquid can be adjusted by controlling the heat exhaust 115 supplied to the heat-exchanger subsystem 120 while the temperature of the high-pressure, hard-surface cleaning liquid can be adjusted by controlling the recirculation ratio of the cleaning liquid itself. The controller, as will be described below, monitors the temperatures and controls the valves that maintain proper temperatures of the cleaning solution.

In one embodiment, the cleaning system 100 is configured to prevent simultaneous operation the low and high-pressure pumps 114, 116 and pathways 140, 160, thus preventing concurrent cleaning of two different materials/surfaces. This one-at-a-time configuration may be more easily achieved because, even though the manipulated variables of the temperature control loops are different, the two control loops would indirectly compete for control, thus resulting in an inefficient and oscillating control pattern. Alternatively, the cleaning system 100 is configured to circulate or recycle both liquids simultaneously to maintain preferred temperatures of the cleaning solutions.

FIG. 3 is a schematic block diagram of various liquid pathways in the vehicle mounted cleaning system, according to one embodiment of the present disclosure. In the depicted embodiment, a water box or tank 302 includes a cold-water inlet (with an inlet water valve) and a low water float sensor 304. Both the water inlet valve and the low water float sensor 304 communicate with the controller. Accordingly, the controller may determine when additional cold water is allowed in to the high pressure cleaning solution tank 302. A low-pressure outlet pathway 306 carries liquid to a high-pressure pump 308. The high-pressure pump 308 is fluidly coupled with the heat exchanger subsystem 120 and a bypass valve 310. In the event that the controller determines, via information received from the pressure gauge 312, that the pressure of the cleaning liquid has exceeded a threshold limit, the controller may direct the bypass valve 310 to divert liquid back to the water tank 302.

Exiting the heat-exchanger subsystem 120 is a high-pressure hot pathway 314. The high-pressure hot pathway 314 flows to an orifice assembly 316 and a high-pressure outlet where a user may connect, via hoses, cleaning devices that use the high-pressure cleaning liquid. The orifice assembly 316, in one embodiment may include filters 318 and pathways that return high-pressure fluid to a recovery tank or back to the water tank 302. For maintenance purposes, the water tank 302 may also include a drain for emptying the water tank 302 when not in use.

As described above, the heat-exchanger subsystem may be formed of different materials, as shown by indicators 120a and 120b. In one embodiment, heat-exchanger subsystem 120a is formed of stainless steel, and heat-exchanger subsystem 120b may be formed of copper. Although in FIG. 3 the heat-exchanger subsystems 120a, 120b are depicted as separate units, they may be formed as a single unit having different internal flow paths that are defined by different materials.

In one embodiment, a thermostat 320 and a high temperature shutdown valve 322 may be disposed on the high-pressure hot pathway 314. In another embodiment, the cleaning solution tank 330 for soft surfaces defines a separate flow path through the heat-exchanger subsystem 120. Exiting the tank 330, the low-pressure flow path passes through a filter 332, pump 334, and check valve 336 into the heat-exchanger subsystem 120a. Exiting the heat-exchanger subsystem 120a is a heated low-pressure flow path that passes through a temperature sensor and diverter 338, a filter 340, and a solution orifice 342.

FIG. 4 is a schematic block diagram of various heat exhaust and vacuum pathways in the vehicle mounted cleaning system, according to one embodiment of the present disclosure. In one embodiment, the system 400 includes a recovery tank 402. The recovery tank receives fluid from a cleaning device (i.e., wand) via pathway 404. The recovered cleaning fluid may pass through a filter 406. Disposed within the recovery tank 402 may be a high-water cutoff switch 408 and an APO float switch 410. When the high-water cutoff switch 408 detects that the cleaning fluid levels are reaching a threshold within the tank 402, the controller may pause cleaning until the user empties the recovery tank 402.

As fluid displaces gas in the recovery tank, the exhausted gas exits through filter 412 and in to an exhaust gas pathway 414 which is forced through the heat-exchanger subsystem 120 by a vacuum blower/pump 118. After passing through the heat-exchanger subsystem 120, the exhaust gas pathway may pass through a blower silencer 416 before exhausting, in one embodiment, to the atmosphere.

Also disposed within the recovery tank 402 may be an APO pump 418 coupled to a check valve 420 and an APO outlet. Additionally, the recovery tank 402 may be configured with a drain.

As described previously, the engine 112 provides heated exhaust via exhaust pathways 422 to the heat-exchanger subsystem 120. The exhaust pathways 422 may pass through a diverter 424 that diverts heated gas/liquid around the heat-exchanger subsystem 120. The controller is configured to control the diverter 424 to modify the temperature of the cleaning fluids flowing through the heat-exchanger subsystem 120. For example, if the temperatures of the fluids are exceeding predetermined thresholds, then the controller may direct the diverter 424 to direct exhaust gasses/liquids around the heat-exchanger subsystem 120 and thereby lower the temperature of the fluids. In an additional embodiment, a vacuum gauge 426 and a blower lube 428 pathway may be provided.

FIG. 5 is a schematic block diagram of a controller 500 in accordance with embodiments of the present disclosure. The controller 500 may include, in one embodiment, various controls/levers/buttons for receiving input from a user. The input may include desired cleaning solutions, solution temperatures, solution pressures, solution flow rates, engine control, etc. Additionally, the controller may include ports for receiving incoming fresh water and blower lubrication, and outputs for sending cleaning solutions to a cleaning device, and outlets for expelling recovered cleaning solution (i.e., extracted solution).

In one embodiment, the controller 500 includes a switch 502 for selecting a temperature of a cleaning solution. For example, the switch 502 may be dedicated to hard-surface cleaning solution temperature. Alternatively, the switch 502 controls the temperature of both hard- and soft-surface cleaning solutions. The controller 500 also includes gauges 504 for displaying the pressure and vacuum of the system 100.

In another embodiment, the controller 500 includes an engine-control panel 506 with controls for controlling the engine. These controls may include a choke 508 and a throttle 510. The hard-surface solution output 512 may be disposed below the throttle 510, or alternatively, positioned anywhere that is convenient. A blower lubrication port 514, an incoming fresh water port 516, and a water tank drain 518 port are also provided.

A solution control panel 520 may also be disposed on the controller 500. The solution control panel 520 includes, in one embodiment, a control dial 522 for selecting the type of surface to be cleaned. Examples include, but are not limited to, flood extraction, carpet/upholstery, and tile/stone. In another embodiment, the solution control panel 520 also includes a port 524 for soft-surface cleaning solution. In other words, a user may connect a cleaning wand to the port 524 for soft surface cleaning.

The controller 500 may also include an auto-pump out switch 526 and an auxiliary switch 528. The controller 500, in some embodiments, may be provided with a display 530 configured to display information useful in the operation of the system 100. In another embodiment, the display 530 is a touchscreen display that is capable of receiving any of the input that was described above with reference to switches and levers. The controller 500, in one embodiment, includes a processor for executing the commands directed to the different components of the system based on the input the processor receives from the sensors, switches, etc. For example, the processor may receiving input from a float switch that the recovery tank is nearing a threshold level, and subsequently shut down the system 100 until the recovery tank is emptied.

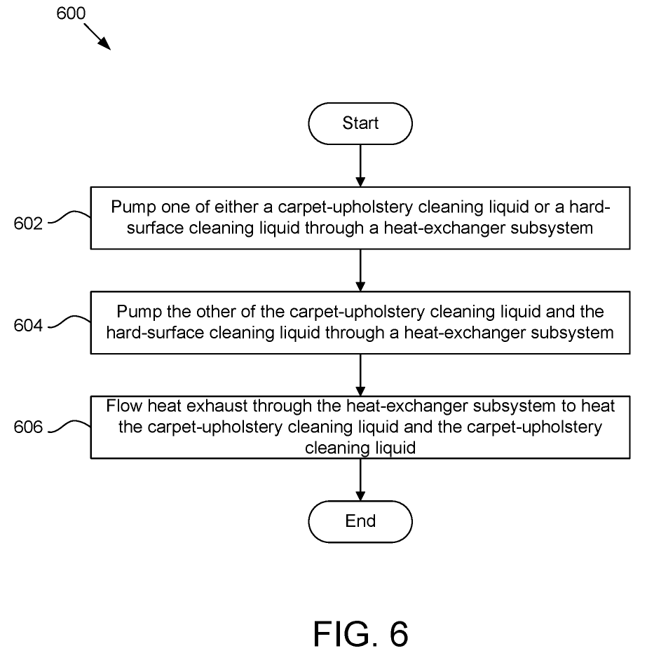

FIG. 6 is a schematic flow chart diagram of a method 600 for successively cleaning two different types of surfaces, according to one embodiment. The method 600 includes pumping 602 one of the carpet-upholstery cleaning liquid through the first heat-receiving pathway of the heat-exchanger subsystem at the first pressure and the hard-surface cleaning liquid through the second heat-receiving pathway of the heat-exchanger subsystem at the second pressure that is higher than the first pressure. The method 600 further includes pumping 604 the other of the carpet-upholstery cleaning liquid through the first heat-receiving pathway of the heat-exchanger subsystem at the first pressure and the hard-surface cleaning liquid through the second heat-receiving pathway of the heat-exchanger subsystem at the second pressure.

Still further, the method 600 includes flowing 606 heat exhaust from at least one of the combustion engine, the vacuum pump, the low-pressure pump, and the high-pressure pump through the heat-providing pathway of the heat-exchanger subsystem to transfer heat to the first heat-receiving pathway and the second heat-receiving pathway of the heat-exchanger subsystem, wherein the first heat-receiving pathway, the second heat-receiving pathway, and the heat-providing pathway are fluidly independent of each other. In one embodiment, only heat exhaust from the combustion engine and the vacuum pump are used in the heat-exchanger subsystem (e.g., no heat exhaust from low and high-pressure pumps flows through the heat-exchanger subsystem).

In one embodiment, the method 600 further includes controlling a temperature of the carpet-upholstery cleaning liquid by diverting heat exhaust from a combustion engine to bypass the heat-providing pathway of the heat-exchanger subsystem. In another embodiment, the method 600 further includes controlling a temperature of the hard-surface cleaning liquid by controlling how much of the hard-surface cleaning liquid recirculates upstream of the heat-exchanger subsystem and how much of the hard-surface cleaning liquid is dumped to a waste tank.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. However, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C; or some other suitable combination. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Aspects of the embodiments may be described above with reference to schematic flowchart diagrams and/or schematic block diagrams of methods, apparatuses, and systems according to embodiments of the disclosure. The schematic flowchart diagrams and/or schematic block diagrams in the figures illustrate the architecture, functionality, and operation of possible implementations of apparatuses, and systems according to various embodiments of the present disclosure. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A vehicle mounted cleaning system switchable between a hard-surface cleaning mode and a carpet-upholstery cleaning mode, the cleaning system comprising:
a power subsystem comprising a combustion engine configured to power a vacuum pump, a low-pressure pump, and a high-pressure pump;
a heat-exchanger subsystem comprising first and second heat-receiving pathways and a heat-providing pathway, wherein heat exhaust from at least one of the combustion engine and the vacuum pump is configured to flow through the heat-providing pathway to transfer heat to both the first and second heat-receiving pathways, wherein the first heat-receiving pathway, the second heat-receiving pathway, and the heat-providing pathway are fluidly independent of each other;
a low-pressure liquid pathway fluidly coupled to the first heat-receiving pathway, wherein, in the carpet-upholstery cleaning mode, a carpet-upholstery cleaning liquid is configured to be pumped, by the low-pressure pump, through the first heat-receiving pathway to a carpet-upholstery cleaning tool; and
a high-pressure liquid pathway fluidly coupled to the second heat-receiving pathway, wherein, in the hard-surface cleaning mode, a hard-surface cleaning liquid is configured to be pumped, by the high-pressure pump, through the second heat-receiving pathway to a hard-surface cleaning tool.

2. The system of claim 1, wherein the heat exhaust configured to flow through the heat-providing pathway is from the combustion engine and the vacuum pump.

3. The system of claim 2, wherein the heat-exchanger subsystem comprises an exhaust diverter operable to route heat exhaust from the combustion engine to bypass the heat-providing pathway, thereby controlling a temperature of the carpet-upholstery cleaning liquid in the carpet-upholstery cleaning mode.

4. The system of claim 1, wherein the high-pressure liquid pathway is coupled to a recirculation manifold downstream from the heat-exchanger subsystem, wherein the recirculation manifold is operable to control how much of the hard-surface cleaning liquid recirculates upstream of the heat-exchanger subsystem and how much of the hard-surface cleaning liquid is dumped to a waste tank, thereby controlling a temperature of the hard-surface cleaning liquid in the hard-surface cleaning mode.

5. The system of claim 1, wherein the combustion engine is independent and separate from a powertrain engine of the vehicle.

6. The system of claim 1, wherein the heat-exchanger subsystem comprises a single heat-exchanger unit.

7. The system of claim 1, wherein the carpet-upholstery cleaning mode and the hard-surface cleaning mode are not concurrently operable.

8. The system of claim 1, further comprising a vacuum pathway fluidly coupling the vacuum pump, a waste tank, and a liquid extraction tool.

9. The system of claim 1, wherein first heat-receiving pathway is made from a first non-corrosive metal material and the second heat-receiving pathway is made from a second metal material different from the first corrosion resistant metal material.

10. A method for successively cleaning both a carpet-upholstery and a hard-surface, the method comprising:
pumping one of a carpet-upholstery cleaning liquid through a first heat-receiving pathway of a heat-exchanger subsystem at a first pressure and a hard-surface cleaning liquid through a second heat-receiving pathway of the heat-exchanger subsystem at a second pressure that is higher than the first pressure;
pumping the other of the carpet-upholstery cleaning liquid through the first heat-receiving pathway of the heat-exchanger subsystem at the first pressure and the hard-surface cleaning liquid through the second heat-receiving pathway of the heat-exchanger subsystem at the second pressure; and
flowing heat exhaust from at least one of a combustion engine, a vacuum pump, through a heat-providing pathway of the heat-exchanger subsystem to transfer heat to the first heat-receiving pathway and the second heat-receiving pathway of the heat-exchanger subsystem, wherein the first heat-receiving pathway, the second heat-receiving pathway, and the heat-providing pathway are fluidly independent of each other.

11. The method of claim 10, further comprising controlling a temperature of the carpet-upholstery cleaning liquid by diverting heat exhaust from a combustion engine to bypass the heat-providing pathway of the heat-exchanger subsystem.

12. The method of claim 10, further comprising controlling a temperature of the hard-surface cleaning liquid by controlling how much of the hard-surface cleaning liquid recirculates upstream of the heat-exchanger subsystem and how much of the hard-surface cleaning liquid is dumped to a waste tank.

13. An apparatus for cleaning that is switchable between a hard-surface cleaning mode and a carpet-upholstery cleaning mode, the system comprising:
a heat-exchanger subsystem comprising first and second heat-receiving pathways and a heat-providing pathway, wherein heat exhaust from a combustion engine is routed through the heat-providing pathway to transfer heat to both the first and second heat-receiving pathways, wherein the first heat-receiving pathway, the second heat-receiving pathway, and the heat-providing pathway are fluidly independent of each other;
a first liquid pathway fluidly coupled to the first heat-receiving pathway, configured to direct a hard-surface cleaning liquid, by a first pump, through the first heat-receiving pathway to a hard-surface cleaning tool; and
a second liquid pathway fluidly coupled to the second heat-receiving pathway, configured to direct a soft-surface cleaning liquid, at a lower pressure than a first liquid in the first liquid pathway, by a second pump, through the second heat-receiving pathway to a soft-surface cleaning tool.

14. The apparatus of claim 13, wherein the heat-exchanger subsystem comprises an exhaust diverter operable to route heat exhaust from the combustion engine to bypass the heat-providing pathway, thereby controlling a temperature of the soft-surface cleaning liquid in the carpet-upholstery cleaning mode.

15. The apparatus of claim 13, wherein the first liquid pathway is coupled to a recirculation manifold downstream from the heat-exchanger subsystem, wherein the recirculation manifold is operable to control how much of the hard-surface cleaning liquid recirculates upstream of the heat-exchanger subsystem and how much of the hard-surface cleaning liquid is dumped to a waste tank, thereby controlling a temperature of the hard-surface cleaning liquid.

16. The apparatus of claim 13, wherein the combustion engine is independent and separate from a powertrain engine of the vehicle.

17. The apparatus of claim 13, wherein the heat-exchanger subsystem comprises a single heat-exchanger unit.

18. The apparatus of claim 13, further comprising a vacuum pathway fluidly coupling a vacuum pump, a waste tank, and a liquid extraction tool.

19. The apparatus of claim 13, wherein first heat-receiving pathway is made from a first non-corrosive metal material and the second heat-receiving pathway is made from a second metal material different from the first corrosion resistant metal material.

20. The apparatus of claim 13, wherein the carpet-upholstery cleaning mode and the hard-surface cleaning mode are not concurrently operable.
